(19) United States
(12) Patent Application Publication
(10) Pub. No.: US 2009/0253338 A1
(43) Pub. Date: Oct. 8, 2009

(54) FLYING OBJECT

(76) Inventor: Mark L. Wilson, Dallas, TX (US)

Correspondence Address: Daniel V. Thompson;Thompson & Gustavson, LLP, 9304 Forest Lane, Suite N253, Dallas, TX, 75243, US

(21) Appl. No.: 12/061,047

(22) Filed: Apr. 2, 2008

(51) Int. Cl. A63H 27/00; A01K 29/00

(52) U.S. Cl. 446/46; 119/707

(57) ABSTRACT

A flying object has an elongate, thin body with two tapered ends on opposite sides of a medial portion.

### FIELD OF THE INVENTION

The present invention relates in general to flying devices. More specifically, but without restriction to the particular use which is shown and described, this invention relates to a flying device for the entertainment of cats and made of an edible film.

### BACKGROUND OF THE INVENTION

Cat toys help keep cats occupied, exercised, and out of trouble. In addition, cat owners enjoy watching their cats play. For these and other reasons, many cat toys are commercially available at pet stores and other retail outlets. However, the right combination of cat-attracting, owner-pleasing, and child-safe attributes remains somewhat elusive and so a need exists for a better cat toy.

Cats respond to the movement of objects and particularly to the challenge of capturing and controlling moving objects. They will paw and bat objects such as balls of twine and bean bags, causing them to move, and then pounce on and play with them. Flying objects simulate birds and insects which are a natural prey of cats, and thus are a desirable type of cat toy. It is challenging, however, to design a man-made flying cat toy that has the right type of flying trajectory. If the object flies too fast, the cat can't see it or loses sight of it—too slow or predictable and the cat loses interest. In addition, it is desirable to have an edible cat toy that doubles as a kitty treat and is thus automatically disposed of at the end of a play session.

Edible films are now used as a handy way of administering breath mints, medications and dietary supplements. Such films are formed of whey protein, cellulose gums or other compounds. When used as a cat toy, the flavor and texture must be desirable to felines. It has not heretofore been known to form edible film into a useful shape or aerodynamic structure.

### SUMMARY OF THE INVENTION

The flying object of the present invention has a geometry which results in a cat-attractive flight trajectory when the object is dropped. Optionally the object may be formed of edible film.

### BRIEF DESCRIPTION OF DRAWINGS

A more complete understanding of the invention and its advantages will be apparent from the Detailed Description taken in conjunction with the accompanying Drawings, in which:

FIG. 1 is a perspective view of the cat toy of the present invention;

FIG. 2 is a top view of the cat toy;

FIG. 3 a side view of the cat toy;

FIG. 4 is an end view of the cat toy; and

FIG. 5 is a diagram indicating the flight characteristics of the cat toy.

### DETAILED DESCRIPTION

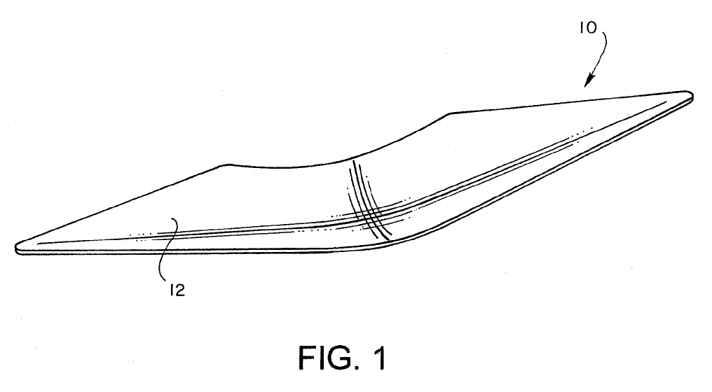

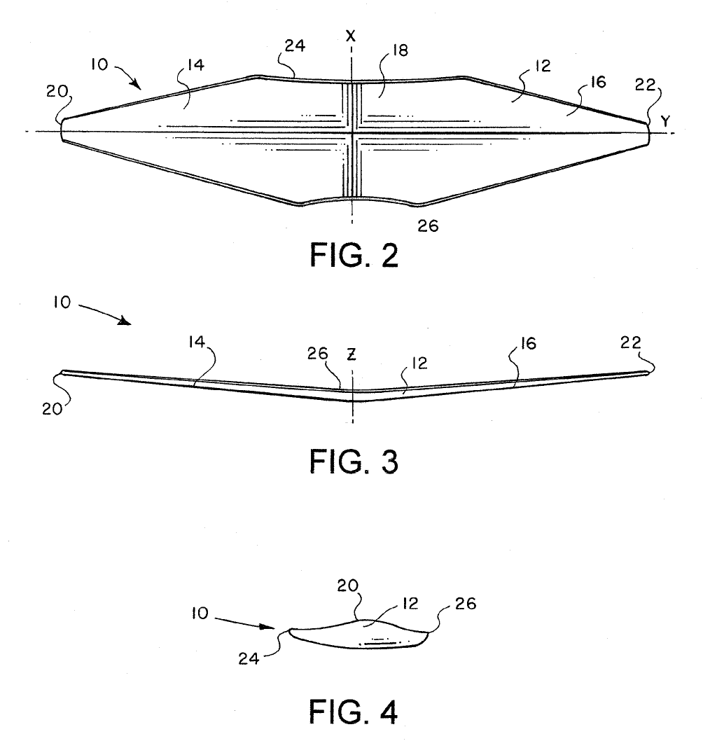

Referring initially to FIGS. 1-4, which drawings are to scale, flying object 10 is an elongate, thin body 12 having length, width and height dimensions, and having X, Y and Z central axes, the X axis being along the width dimension, the Y axis being along the length dimension, and the Z axis being along the height dimension.

Body 12 has two ends 14,16 on opposite sides of a medial portion 18 along the Y axis. The length dimension between the two ends 14,16 is about 4 times the width dimension at the medial portion 18. The medial portion 18 has a length dimension of about one-third of the total length dimension between the ends.

Ends 14,16 are tapered symmetrically about the Y axis from the medial portion 18 to terminal edges 20,22. Terminal edges 20,22 are rounded. The width of the terminal edges 20,22 is about one-fourth of the total width dimension of the medial portion 18.

The medial portion 18 has slightly concave side edges 24,26 generally parallel to the Y axis. As shown in FIG. 3, the body medial portion 18 is slightly bent along the X axis so that the medial portion 18 and tapered ends 14,16 have a dihedral angle with respect to the Z axis of about 5 degrees.

As shown in FIG. 4, the body 12 has a curved camber along the X axis and about the Y axis.

The body 12 may be formed of a thin, edible film attractive in flavor and texture to cats.

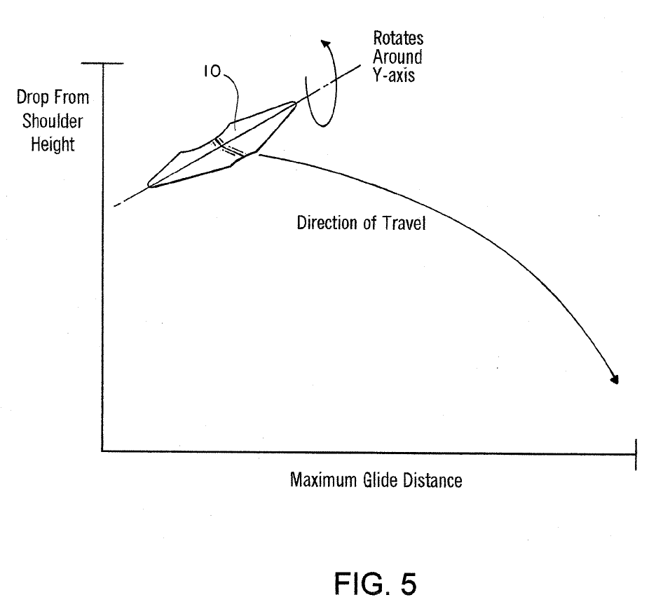

In operation, as shown in FIG. 5, the cat toy is released from shoulder height and assumes a slow, unpredictable, gliding trajectory to the ground. It is desirable to extend the glide distance as much as possible to prolong the play experience for the cat. The object rotates rapidly about the Y axis.

When aerodynamic wings are designed, it is normally desired to minimize turbulence in order to produce a wing delivering the greatest amount of stability possible. In the present invention, however, turbulence is designed into the wing shaped object to induce instability and achieve unpredictability. The flight characteristics desired are: 1. fastest Y-axis rotation rate, 2. maximum glide distance, and 3. unpredictable glide path.

The four key elements of the geometry include the rounded and tapered ends, the dihedral, the camber and symmetry. The combination of the disclosed features maximizes turbulence and creates the most unstable object possible. As a result, this object tumbles and flutters to the ground in predictably unpredictable ways. Whereas most wings perform by creating lift through a configuration involving air speed and a positive angle of attack, this object's geometry generates wild instability and a tumbling rotation about the Y axis. The tumbling rotation generates lift, prolonging the flight time and glide distance, as well as generating a “fluttering” behavior falling to the ground.

The tapered ends minimize drag by providing a smaller width at the tips. The reduced drag ensures that airflow velocity is maximized. The rounding of the terminal edges optimizes the rotation rate by ensuring that vortices form at the tips thus causing a continuous moment about the Y axis. These features extend the glide distance.

The dihedral optimizes lateral stability for a generally-straight glide path. An object without dihedral will side slip and spiral to the ground, reducing glide distance. The object's various twists and turns created by the spinning and straightening out of the glide path results in an overall unpredictable though generally-straight trajectory.

Camber permits the object to begin Y-axis rotation without regard to the angle at which the object is dropped. An object without camber will transition to spinning only if dropped at certain angles.

Symmetry about the X axis ensures that the center of gravity is located at the center of the object. This minimizes rotation/spinning about the X axis allowing a more stable spin about the Y axis.

The slight concave curvature at edges 24,26 is cosmetic and does not affect the flight trajectory.

It will be understood that each of the elements described above, or two or more together, may also find a useful application in other types of constructions differing from the type described above. In particular, the flying object may be used in applications other than as a cat toy and need not necessarily be formed of edible film.

While the invention has been illustrated and described as embodied in a particular cat toy, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A flying object, comprising;
an elongate, thin body having length, width and height dimensions, and having X, Y and Z central axes, the X axis being along the width dimension, the Y axis being along the length dimension, and the Z axis being along the height dimension;
the body having two ends on opposite sides of a medial portion along the Y axis; and
the ends being tapered symmetrically about the Y axis from the medial portion.

2. The flying object of claim 1 with terminal edges of the ends being rounded.

3. The flying object of claim 1 with the length dimension between the two ends being about 4 times the width dimension at the medial portion.

4. The flying object of claim 1 with the medial portion having a length dimension of about one-third of the total length dimension between the ends.

5. The flying object of claim 1 with terminal edges of the ends having a width dimension of about one-fourth of the total width dimension of the medial portion.

6. The flying object of claim 1 with the medial portion having slightly concave side edges generally parallel to the Y axis.

7. The flying object of claim 1 with the body medial portion being slightly bent along the X axis so that the medial portion and tapered ends have a dihedral angle with respect to the Z axis of about 5 degrees.

8. The flying object of claim 1 with the body having a curved camber along the X axis and about the Y axis.

9. The flying object of claim 1 with the body formed of a thin, edible film.

10. A flying object, comprising;
an elongate, thin body having length, width and height dimensions, and having X, Y and Z central axes, the X axis being along the width dimension, the Y axis being along the length dimension, and the Z axis being along the height dimension;
the body having two ends on opposite sides of a medial portion along the Y axis;
the ends being tapered symmetrically about the Y axis from the medial portion to terminal edges of the ends;
with the terminal edges being rounded; and
with the body having a curved camber along the X axis and about the Y axis.

11. The flying object of claim 10 with the length dimension between the two ends being about 4 times the width dimension at the medial portion.

12. The flying object of claim 10 with the medial portion having a length dimension of about one-third of the total length dimension between the ends.

13. The flying object of claim 10 with terminal edges of the ends having a width dimension of about one-fourth of the total width dimension of the medial portion.

14. The flying object of claim 10 with the medial portion having slightly concave side edges generally parallel to the Y axis.

15. The flying object of claim 10 with the body medial portion being slightly bent along the X axis so that the medial portion and tapered ends have a dihedral angle with respect to the Z axis of about 5 degrees.

16. The flying object of claim 10 with the body formed of a thin, edible film.

17. The flying object of claim 15 with the length dimension between the two ends being about 4 times the width dimension at the medial portion.

18. The flying object of claim 15 with the medial portion having a length dimension of about one-third of the total length dimension between the ends.

19. The flying object of claim 15 with terminal edges of the ends having a width dimension of about one-fourth of the total width dimension of the medial portion.

20. A flying object, comprising;
an elongate, thin body having length, width and height dimensions, and having X, Y and Z central axes, the X axis being along the width dimension, the Y axis being along the length dimension, and the Z axis being along the height dimension;
the body having two ends on opposite sides of a medial portion along the Y axis;
the length dimension between the two ends being about 4 times the width dimension at the medial portion;
the medial portion having a length dimension of about one-third of the total length dimension between the ends;
the ends being tapered symmetrically about the Y axis from the medial portion to terminal edges of the ends, with the terminal edges of the ends being rounded;
with the terminal edges of the ends having a width dimension of about one-fourth of the total width dimension of the medial portion;
the medial portion having slightly concave side edges generally parallel to the Y axis;
the body medial portion being slightly bent along the X axis so that the medial portion and tapered ends have a dihedral angle with respect to the Z axis of about 5 degrees;
the body having a curved camber along the X axis and about the Y axis; and
the body formed of a thin, edible film.
